(19) United States
(12) Patent Application Publication
(10) Pub. No.: US 2012/0191896 A1
(43) Pub. Date: Jul. 26, 2012

(54) CIRCUITRY TO SELECT, AT LEAST IN PART, AT LEAST ONE MEMORY

(76) Inventors: Zhen Fang, Portland, OR (US); Li Zhao, Beaverton, OR (US); Ravishankar Iyer, Portland, OR (US); Srihari Makineni, Portland, OR (US); Guangdeng Liao, Riverside, CA (US)

(21) Appl. No.: 13/013,104

(22) Filed: Jan. 25, 2011

(51) Int. Cl. G06F 12/08

(52) U.S. Cl. 711/6; 711/E12.016

(57) ABSTRACT

An embodiment may include circuitry to select, at least in part, from a plurality of memories, at least one memory to store data. The memories may be associated with respective processor cores. The circuitry may select, at least in part, the at least one memory based at least in part upon whether the data is included in at least one page that spans multiple memory lines that is to be processed by at least one of the processor cores. If the data is included in the at least one page, the circuitry may select, at least in part, the at least one memory, such that the at least one memory is proximate to the at least one of the processor cores. Many alternatives, variations, and modifications are possible.

### FIELD

This disclosure relates to circuitry to select, at least in part, at least one memory.

### BACKGROUND

In one conventional computing arrangement, a host includes a host processor and a network interface controller. The host processor includes multiple processor cores. Each of the processor cores has a respective local cache memory. One of the cores manages a transport protocol connection implemented via the network interface controller.

In this conventional arrangement, when an incoming packet that is larger than a single cache line is received by the network interface controller, a conventional direct cache access (DCA) technique is employed to directly transfer the packet to and store the packet in last-level cache in the memories. More specifically, in this conventional technique, data in the packet is distributed across multiple of the cache memories, including one or more such memories that are remote from the processor core that is managing the connection. Therefore, in order to be able to process the packet, the processor core that is managing the connection fetches the data that is stored in the remote memories and stores it in that core's local cache memory. This increases the amount of time involved in accessing and processing the packet's data. It also increases the amount of power consumed by the host processor.

Other conventional techniques (e.g., flow-pinning employed by some operating system kernels in connection with receive-side scaling and interrupt request affinity techniques) have been employed in an effort to try to improve processor data locality and load balancing. However, these other conventional techniques may still result in incoming packet data being stored in one or more cache memories that are remote from the processor core that is managing the connection.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates features in an embodiment.

FIG. 3 illustrates features in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

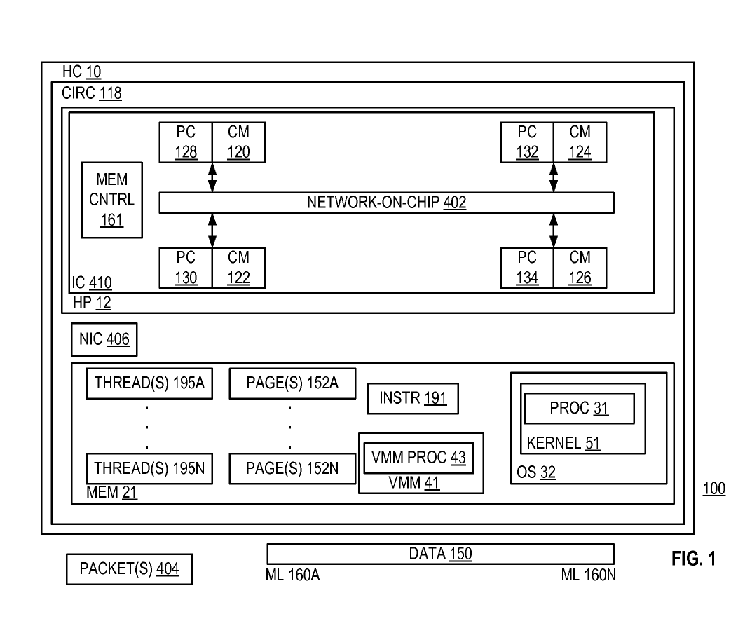

FIG. 1 illustrates a system embodiment 100. System 100 may include host computer (HC) 10. In this embodiment, the terms “host computer,” “host,” “server,” “client,” “network node,” and “node” may be used interchangeably, and may mean, for example, without limitation, one or more end stations, mobile internet devices, smart phones, media devices, input/output (I/O) devices, tablet computers, appliances, intermediate stations, network interfaces, clients, servers, and/or portions thereof. In this embodiment, data and information may be used interchangeably, and may be or comprise one or more commands (for example one or more program instructions), and/or one or more such commands may be or comprise data and/or information. Also in this embodiment, an “instruction” may include data and/or one or more commands.

HC 10 may comprise circuitry 118. Circuitry 118 may comprise, at least in part, one or more multi-core host processors (HP) 12, computer-readable/writable host system memory 21, and/or network interface controller (NIC) 406. Although not shown in the Figures, HC 10 also may comprise one or more chipsets (comprising, e.g., memory, network, and/or input/output controller circuitry). HP 12 may be capable of accessing and/or communicating with one or more other components of circuitry 118, such as, memory 21 and/or NIC 406.

In this embodiment, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry. Also in this embodiment, a processor, central processing unit (CPU), processor core (PC), core, and controller each may comprise respective circuitry capable of performing, at least in part, one or more arithmetic and/or logical operations, and/or of executing, at least in part, one or more instructions. Although not shown in the Figures, HC 10 may comprise a graphical user interface system that may comprise, e.g., a respective keyboard, pointing device, and display system that may permit a human user to input commands to, and monitor the operation of, HC 10 and/or system 100.

In this embodiment, memory may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory. One or more machine-readable program instructions 191 may be stored, at least in part, in memory 21. In operation of HC 10, these instructions 191 may be accessed and executed by one or more host processors 12 and/or NIC 406. When executed by one or more host processors 12, these one or more instructions 191 may result in one or more operating systems (OS) 32, one or more virtual machine monitors (VMM) 41, and/or one or more application threads 195A . . . 195N being executed at least in part by one or more host processors 12, and becoming resident at least in part in memory 21. Also when instructions 191 are executed by one or more host processors 12 and/or NIC 406, these one or more instructions 191 may result in one or more host processors 12, NIC 406, one or more OS 32, one or more VMM 41, and/or one or more components thereof, such as, one or more kernels 51, one or more OS kernel processes 31, one or more VMM processes 43, performing operations described herein as being performed by these components of system 100.

In this embodiment, one or more OS 32, VMM 41, kernels 51, processes 31, and/or processes 43 may be mutually distinct from each other, at least in part. Alternatively or additionally, without departing from this embodiment, one or more respective portions of one or more OS 32, VMM 41, kernels 51, processes 31, and/or processes 43 may not be mutually distinct, at least in part, from each other and/or may be comprised, at least in part, in each other. Likewise, without departing from this embodiment, NIC 406 may be distinct from one or more not shown chipsets and/or HP 12. Alternatively or additionally, NIC 406 and/or the one or more chipsets may be comprised, at least in part, in HP 12 or vice versa.

In this embodiment, HP 12 may comprise an integrated circuit chip 410 that may comprise a plurality of PC 128, 130, 132, and/or 134, a plurality of memories 120, 122, 124, and/or 126, and/or memory controller 161 communicatively coupled together by a network-on-chip 402. Alternatively, memory controller 161 may be distinct from chip 410 and/or may be comprised in the not shown chipset. Also additionally or alternatively, chip 410 may comprise a plurality of integrated circuit chips (not shown).

In this embodiment, a portion or subset of an entity may comprise all or less than all of the entity. Also, in this embodiment, a process, thread, daemon, program, driver, operating system, application, kernel, and/or VMM each may (1) comprise, at least in part, and/or (2) result, at least in part, in and/or from, execution of one or more operations and/or program instructions. Thus, in this embodiment, one or more processes 31 and/or 43 may be executed, at least in part, by one or more of the PC 128, 130, 132, and/or 134.

In this embodiment, an integrated circuit chip may be or comprise one or more microelectronic devices, substrates, and/or dies. Also in this embodiment, a network may be or comprise any mechanism, instrumentality, modality, and/or portion thereof that permits, facilitates, and/or allows, at least in part, two or more entities to be communicatively coupled together. In this embodiment, a first entity may be “communicatively coupled” to a second entity if the first entity is capable of transmitting to and/or receiving from the second entity one or more commands and/or data.

Memories 120, 122, 124, and/or 126 may be associated with respective PC 128, 130, 132, and/or 134. In this embodiment, the memories 120, 122, 124, and/or 126 may be or comprise, at least in part, respective cache memories (CM) that may be primarily intended to be accessed and/or otherwise utilized by, at least in part, the respective PC 128, 130, 132, and/or 134 with which the respective memories may be associated, although one or more PC may also be capable of accessing and/or utilizing, at least in part, one or more of the memories 120, 122, 124, and/or 126 with which they may not be associated.

For example, one or more CM 120 may be associated with one or more PC 128 as one or more local CM of one or more PC 128, while the other CM 122, 124, and/or 126 may be relatively more remote from one or more PC 128 (e.g., compared to one or more CM 120). Similarly, one or more CM 122 may be associated with one or more PC 130 as one or more local CM of one or more PC 130, while the other CM 120, 124, and/or 126 may be relatively more remote from one or more PC 130 (e.g., compared to one or more CM 122). Additionally, one or more CM 124 may be associated with one or more PC 132 as one or more local CM of one or more PC 132, while the other CM 120, 122, and/or 126 may be relatively more remote from one or more PC 132 (e.g., compared to one or more CM 124). Also, one or more CM 126 may be associated with one or more PC 134 as one or more local CM of one or more PC 134, while the other CM 120, 122, and/or 124 may be relatively more remote from one or more PC 134 (e.g., compared to one or more local CM 126).

Network-on-chip 402 may be or comprise, for example, a ring interconnect having multiple respective stops (e.g., not shown respective communication circuitry of respective slices of chip 410) and circuitry (not shown) to permit data, commands, and/or instructions to be routed to the stops for processing and/or storage by respective PC and/or associated CM that may be coupled to the stops. For example, each respective PC and its respective associated local CM may be coupled to one or more respective stops. Memory controller 161, NIC 406, and/or one or more of the PC 128, 130, 132, and/or 134 may be capable of issuing commands and/or data to the network-on-chip 402 that may result, at least in part, in network-on-chip 402 routing such data to the respective PC and/or its associated local CM (e.g., via the one or more respective stops that they may be coupled to) that may be intended to process and/or store the data. Alternatively or additionally, network-on-chip 402 may comprise one or more other types of networks and/or interconnects (e.g., one or more mesh networks) without departing from this embodiment.

In this embodiment, a cache memory may be or comprise memory that is capable of being more quickly and/or easily accessed by one or more entities (e.g., one or more PC) than another memory (e.g., memory 21). Although, in this embodiment, the memories 120, 122, 124, and/or 126 may comprise respective lower level cache memories, other and/or additional types of memories may be employed without departing from this embodiment. Also in this embodiment, a first memory may be considered to be relatively more local to an entity than a second memory if the first memory may be accessed more quickly and/or easily by the entity than second memory may be accessed by the entity. Additionally or alternatively, the first memory and the second memory may be considered to be a local memory and a remote memory, respectively, with respect to the entity if the first memory is intended to be accessed and/or utilized primarily by the entity but the second memory is not intended to be primarily accessed and/or utilized by the entity.

One or more processes 31 and/or 43 may generate, allocate, and/or maintain, at least in part, in memory 21 one or more (and in this embodiment, a plurality of) pages 152A . . . 152N. Each of the pages 152A . . . 152N may comprise respective data. For example, in this embodiment, one or more pages 152A may comprise data 150. Data 150 and/or one or more pages 152A may be intended to be processed by one or more of the PC (e.g., PC 128) and may span multiple memory lines (ML) 160A . . . 160N of one or more CM 120 that may be local to and associated with the one or more PC 128. For example, in this embodiment, a memory and/or cache line of a memory may comprise an amount (e.g., the smallest amount) of data that may be discretely addressable when stored in the memory. Data 150 may be comprised in and/or generated based at least in part upon one or more packets 404 that may be received, at least in part, by NIC 406. Alternatively or additionally, data 150 may be generated, at least in part by, and/or as a result at least in part of the execution of one or more threads 195N by one or more PC 134. In either case, one or more respective threads 195A may be executed, at least in part, by one or more PC 128. One or more threads 195A and/or one or more PC 128 may be intended to utilize and/or process, at least in part, one or more pages 152A, data 150, and/or one or more packets 404. The one or more PC 128 may (but are not required to) comprise multiple PC that may execute respective threads comprised in one or more threads 195A. Additionally, data 150 and/or one or more packets 404 may be comprised in one or more pages 152A.

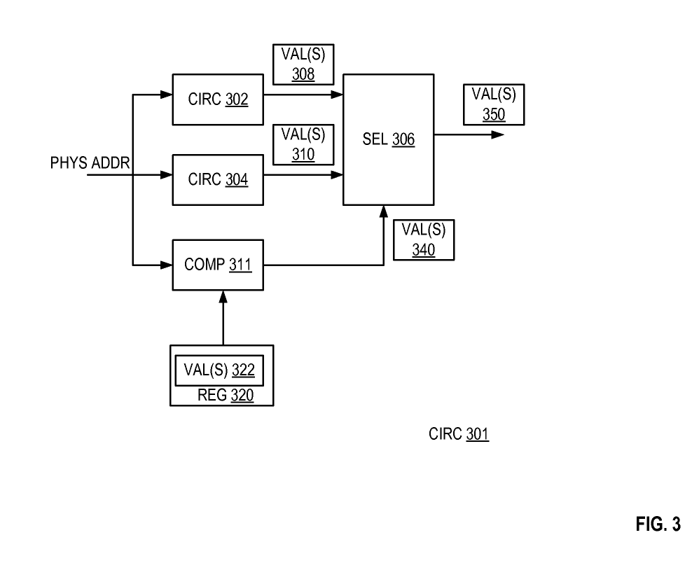

In this embodiment, circuitry 118 may comprise circuitry 301 (see FIG. 3) to select, at least in part, from the memories 120, 122, 124, and/or 126, one or more memories (e.g., CM 120) to store data 150 and/or one or more pages 152A. Circuitry 301 may select, at least in part, these one or more memories 120 from among the plurality of memories based at least in part upon whether (1) the data 150 and/or one or more pages 152A span multiple memory lines (e.g., cache lines 160A . . . 160N), (2) the data 150 and/or one or more pages 152A are intended to be processed by one or more PC (e.g., PC 128) associated with the one or more memories 120, and/or (3) the data 150 are comprised in the one or more pages 152A. Circuitry 301 may select, at least in part, these one or more memories 120 in such a way and/or such that the one or more memories 120, thus selected, may be proximate to the PC 128 that is to process the data 150 and/or one or more pages 152A. In this embodiment, a memory may be considered to be proximate to a PC if the memory is local to the PC and/or is relatively more local to the PC than one or more other memories may be.

In this embodiment, circuitry 301 may be comprised, at least in part, in chip 410, controller 161, the not shown chipset, and/or NIC 406. Of course, many modifications, alternatives, and/or variations are possible in this regard without departing from this embodiment, and therefore, circuitry 301 may be comprised elsewhere, at least in part, in circuitry 118.

As shown in FIG. 3, circuitry 301 may comprise circuitry 302 and circuitry 304. Circuitry 302 and circuitry 304 may concurrently generate, at least in part, respective output values 308 and 310 indicating, at least in part, one or more of the CM 120, 122, 124, and/or 126 to be selected by circuitry 301. Without departing from this embodiment, however, such generation may not be concurrent, at least in part. Circuitry 302 may generate, at least in part, one or more output values 308 based at least in part upon a (e.g., cache) memory line-by-memory line allocation algorithm. Circuitry 304 may generate, at least in part, one or more output values 310 based at least in part upon a page-by-page allocation algorithm. Both the memory line-by-memory line allocation algorithm and the page-by-page allocation algorithm may respectively generate, at least in part, the respective output values 308 and 310 based upon one or more physical addresses (PHYS ADDR) respectively input to the algorithms. The memory line-by-memory line allocation algorithm may comprise one or more hash functions to determine one or more stops (e.g., corresponding to the one or more of the CM selected) of the network-on-chip 402 to which to route the data 150 (e.g., in accordance with a cache line interleaving/allocation-based scheme that allocates data for storage/processing among the CM 120, 122, 124, 126 and/or PC 128, 130, 132, and/or 134 in HP 12). The page-by-page allocation algorithm may comprise one or more mapping functions to determine one or more stops (e.g., corresponding to the one or more of the CM selected) of the network-on-chip 402 to which to route the data 150 and/or one or more pages 152A (e.g., in accordance with a page-based interleaving/allocation scheme that allocates data and/or pages for storage/processing among the CM 120, 122, 124, 126 and/or PC 128, 130, 132, and/or 134 in HP 12). The page-based interleaving/allocation scheme may allocate the data 150 and/or one or more pages 152A to the one or more selected CM on a page-by-page basis (e.g., in units of one or more pages), in contradistinction to the cache line interleaving/allocation-based scheme, which latter scheme may allocate the data 150 among one or more selected CM on a cache-line-by-cache-line basis (e.g., in units of individual cache lines). In accordance with this page-based interleaving/allocation scheme, the one or more values 310 may be equal to the remainder (R) that results from the division of respective physical page number(s) (P) of one or more pages 152A by the aggregate number (N) of stops/slices corresponding to CM 120, 122, 124, 126. When put into mathematical terms, this may be expressed as:

R=P mod N.

Circuitry 301 may comprise selector circuitry 306. Selector circuitry 306 may select one set of the respective values 308, 310 to output from circuitry 301 as one or more values 350. The one or more values 350 output from circuitry 301 may select and/or correspond, at least in part, to one or more stops of the network-on-chip 402 to which to route the data 150 and/or one or more pages 152A. These one or more stops may correspond, at least in part, to (and therefore select) the one or more CM (e.g., CM 120) that is to store the data 150 and/or one or more pages 152A. For example, in response, at least in part, to the one or more output values 350, controller 161 and/or network-on-chip 402 may route the data 150 and/or one or more pages 152A to these one or more stops, and the one or more CM 120 that correspond to these one or more stops may store the data 150 and/or one or more pages 152A routed thereto.

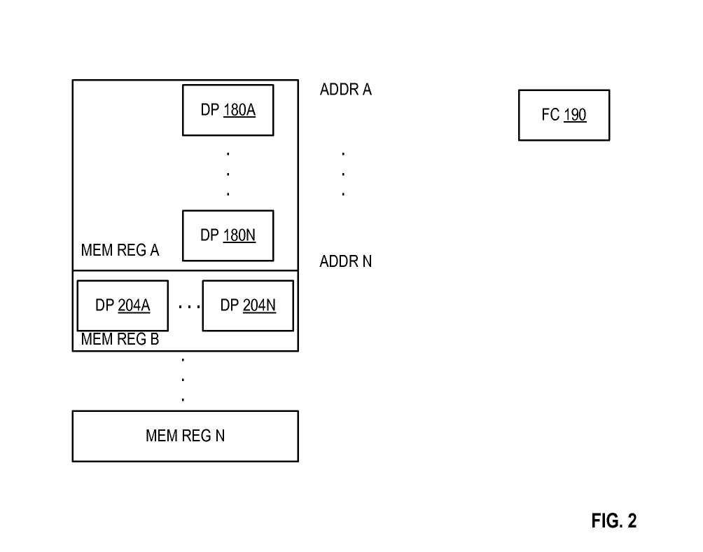

Circuitry 306 may select which of the one or more values 308, 310 to output from circuitry 301 as one or more values 350 based at least in part upon the one or more physical addresses PHYS ADDR and one or more physical memory regions in which these one or more physical addresses PHYS ADDR may be located. This latter criterion may be determined, at least in part, by comparator circuitry 311 in circuitry 301. For example, comparator 311 may receive, as inputs, the one or more physical addresses PHYS ADDR and one or more values 322 stored in one or more registers 320. The one or more values 322 may correspond to a maximum physical address (e.g., ADDR N in FIG. 2) of one or more physical memory regions (e.g., MEM REG A in FIG. 2). Comparator 311 may compare one or more physical addresses PHYS ADDR to one or more values 322. If the one or more physical addresses PHYS ADDR are less than or equal to one or more values 322 (e.g., if one or more addresses PHYS ADDR corresponds to ADDR A in one or more regions MEM REG A), comparator 311 may output one or more values 340 to selector 306 that may indicate that one or more physical addresses PHYS ADDR are located in one or more memory regions MEM REG A in FIG. 2. This may result in selector 306 selecting, as one or more values 350, one or more values 310.

Conversely, if the one or more physical addresses PHYS ADDR are greater than one or more values 322, comparator may output one or more values 340 to selector 306 that may indicate that one or more physical addresses PHYS ADDR are not located in one or more memory regions MEM REG A, but instead may be located in one or more other memory regions (e.g., in one or more of MEM REG B . . . N, see FIG. 2). This may result in selector 306 selecting, as one or more values 350, one or more values 308.

For example, as shown in FIG. 2, one or more processes 31 and/or 43 may configure, allocate, establish, and/or maintain, at least in part, in memory 21 at runtime following restart of HC 10 memory regions MEM REG A . . . N. One or more (e.g., MEM REG A) of these regions MEM REG A . . . N may be devoted to storing one or more pages of data that are to be allocated and/or routed to, and/or stored in, one or more selected CM in accordance with the page-based interleaving/allocation scheme. Conversely, one or more others memory regions (e.g., MEM REG B . . . N) may be devoted to storing one or more pages of data that are to be allocated and/or routed to, and/or stored in, one or more selected CM in accordance with the cache line interleaving/allocation-based scheme. Contemporaneously with the establishment of memory regions MEM REG A . . . N, one or more processes 31 and/or 43 may store in one or more registers 320 one or more values 322.

As seen previously, one or more physical memory regions MEM REG A may comprise one or more (and in this embodiment, a plurality of) physical memory addresses ADDR A . . . N. One or more memory regions MEM REG A and/or memory addresses ADDR A . . . N may be associated, at least in part, with (and/or store) one or more data portions (DP) 180A . . . 180N that are to be distributed to one or more of the CM based at least in part upon the page-based interleaving/allocation scheme (e.g., on a whole page-by-page allocation basis).

Conversely, one or more memory regions MEM REG B may be associated, at least in part, with (and/or store) one or more other DP 204A . . . 204N that are to be distributed to one or more of the CM based at least in part upon the cache line interleaving/allocation-based scheme (e.g., on an individual cache memory line-by-cache-memory line allocation basis).

By way of example, in operation, after one or more packets 404 are received, at least in part, by NIC 406, one or more processes 31, one or more processes 43, and/or one or more threads 195A executed by one or more PC 128 may invoke a physical page memory allocation function call 190 (see FIG. 2). In this embodiment, although many alternatives are possible, one or more threads 195A may process packet 404 and/or data 150 in accordance with a Transmission Control Protocol (TCP) described in Internet Engineering Task Force (IETF) Request For Comments (RFC) 791 published September 1981. In response to, at least in part, and/or contemporaneous with the invocation of call 190 by one or more threads 195A, one or more processes 31 and/or 43 may allocate, at least in part, physical addresses ADDR A . . . N in one or more regions MEM REG A, and may store DP 180A . . . 180N in one or more memory regions MEM REG A in association with (e.g., at) addresses ADDR A . . . N. In this example, DP 180A . . . 180N may be comprised in one or more pages 152A, and one or more pages 152A may be comprised in one or more memory regions MEM REG A. DP 180A . . . 180N may comprise respective subsets of data 150 and/or one or more packets 404 that when appropriately aggregated may correspond to data 150 and/or one or more packets 404.

One or more processes 31 and/or 43 may select (e.g., via receive side scaling and/or interrupt request affinity mechanisms) which PC (e.g., PC 128) in HP 12 may execute one or more threads 195A intended to process and/or consume data 150 and/or one or more packets 404. One or more processes 31 and/or 43 may select one or more pages 152A and/or addresses ADDR A . . . N in one or more regions MEM REG A to store DP 180A . . . 180N that may map (e.g., in accordance with the page-based interleaving/allocation scheme) to the CM (e.g., CM 120) associated with the PC 128 that executes one or more threads 195A. This may result in circuitry 301 selecting, as one or more values 350, one or more values 310 that may result in one or more pages 152A being routed and stored, in their entirety, to one or more CM 120. As a result, one or more threads 195A executed by one or more PC 128 may access, utilize, and/or process data 150 and/or one or more packets 404 entirely from one or more local CM 120.

Advantageously, in this embodiment, this may permit all of the data 150 and/or the entirety of one or more packets 404 that are intended to be processed by one or more threads 195A to be stored in the particular slice and/or one or more CM 120 that may be local with respect to the one or more PC 128 executing the one or more threads 195A, instead of being distributed in one or more remote slices and/or CM. This may significantly reduce the time involved in accessing and/or processing data 150 and/or one or more packets 404 by one or more threads 195A in this embodiment. Also, in this embodiment, this may permit one or more slices and/or PC other than the particular slice and PC 128 involved in executing one or more threads 195A to be put into and/or remain in relatively low power states (e.g., relative to higher power and/or fully operational states). Advantageously, this may permit power consumption by the HP 12 to be reduced in this embodiment. Furthermore, in this embodiment, if data 150 and/or one or more packets 404 exceed the size of one or more CM 120, one or more other pages in one or more pages 152A may be stored, on a whole page-by-page basis, based upon CM proximity to one or more PC 128. Advantageously, in this embodiment, this may permit these one or more other pages to be stored in one or more other, relatively less remote CM (e.g., CM 122) than one or more of the other available CM (e.g., CM 124). Further advantageously, the foregoing teachings of this embodiment may be applied to improve performance of data consumer/producer scenarios other than and/or in addition to TCP/packet processing.

Additionally, in this embodiment, in the case in where it may not be desired to impose affinity between data 150 and one or more PC intended to process data 150, data 150 may be stored in one or more memory regions other than one or more regions MEM REG A. This may result in circuitry 301 selecting, as one or more values 350, one or more values 308 that may result in data 150 being routed and stored in one or more CM in accordance with the cache line interleaving/allocation-based scheme. Thus, advantageously, this embodiment may exhibit improved flexibility in terms of the interleaving/allocation scheme that may be employed, depending upon the type of data that is to be routed. Further advantageously, in this embodiment, if it is desired, DCA still may be employed.

Thus, an embodiment may include circuitry to select, at least in part, from a plurality of memories, at least one memory to store data. The memories may be associated with respective processor cores. The circuitry may select, at least in part, the at least one memory based at least in part upon whether the data is included in at least one page that spans multiple memory lines that is to be processed by at least one of the processor cores. If the data is included in the at least one page, the circuitry may select, at least in part, the at least one memory, such that the at least one memory is proximate to the at least one of the processor cores.

Many modifications are possible. Accordingly, this embodiment should be viewed broadly as encompassing all such alternatives, modifications, and alternatives.

What is claimed is:

1. An apparatus comprising:
circuitry to select, at least in part, from a plurality of memories, at least one memory to store data, the plurality of memories being associated with respective processor cores, the circuitry being to select, at least in part, the at least one memory based at least in part upon whether the data is comprised in at least one page that spans multiple memory lines that is to be processed by at least one of the processor cores, and if the data is comprised in the at least one page, the circuitry being to select, at least in part, the at least one memory, such that the at least one memory is proximate to the at least one of the processor cores.

2. The apparatus of claim 1, wherein:
the at least one page is allocated, at least in part, one or more physical memory addresses by at least one process executed, at least in part, by one or more of the processor cores;
the one or more physical memory addresses are in a first physical memory region associated, at least in part, with one or more first data portions to be distributed to the memories based at least in part upon a page-by-page allocation;
the at least one process is to allocate, at least in part, a second physical memory region associated, at least in part, with one or more second data portions to be distributed to the memories based at least in part upon a memory line-by-memory line allocation; and
the circuitry is to select, at least in part, the at least one memory based at least in part upon the one or more physical addresses and in which of the physical memory regions the one or more physical memory addresses are located.

3. The apparatus of claim 2, wherein:
the at least one process is to allocate, at least in part, the one or more physical memory addresses in response, at least in part, to and contemporaneous with invocation of a memory allocation function call; and
the at least one process comprises at least one operating system kernel process.

4. The apparatus of claim 2, wherein:
the circuitry comprises:
first circuitry and second circuitry to concurrently generate, at least in part, respective values indicating, at least in part, the at least one memory, based at least in part upon the memory line-by-memory line allocation and the page-by-page allocation, respectively; and
selector circuitry to select one of the respective values based at least in part upon the one or more physical addresses and in which of the physical memory regions the one or more physical memory addresses are located.

5. The apparatus of claim 1, wherein:
the plurality of processor cores are communicatively coupled to each other via at least one network-on-chip;
the at least one page comprises, at least in part, at least one packet received, at least in part, by a network interface controller, the at least one packet including the data; and
the plurality of processor cores, the memories, and the network-on-chip are comprised in an integrated circuit chip.

6. The apparatus of claim 1, wherein:
the at least one memory is local to the at least one of the processor cores and also is remote from one or more others of the processor cores;
the at least one of the processor cores comprises multiple processor cores to execute respective application threads to utilize, at least in part, the at least one page; and
the at least one page is allocated, at least in part, by at least one virtual machine monitor process.

7. A method comprising:
selecting, at least in part, by circuitry, from a plurality of memories at least one memory to store data, the plurality of memories being associated with respective processor cores, the circuitry being to select, at least in part, the at least one memory based at least in part upon whether the data is comprised in at least one page that spans multiple memory lines that is to be processed by at least one of the processor cores, and if the data is comprised in the at least one page, the circuitry being to select, at least in part, the at least one memory, such that the at least one memory is proximate to the at least one of the processor cores.

8. The method of claim 7, wherein:
the at least one page is allocated, at least in part, one or more physical memory addresses by at least one process executed, at least in part, by one or more of the processor cores;
the one or more physical memory addresses are in a first physical memory region associated, at least in part, with one or more first data portions to be distributed to the memories based at least in part upon a page-by-page allocation;
the at least one process is to allocate, at least in part, a second physical memory region associated, at least in part, with one or more second data portions to be distributed to the memories based at least in part upon a memory line-by-memory line allocation; and
the circuitry is to select, at least in part, the at least one memory based at least in part upon the one or more physical addresses and in which of the physical memory regions the one or more physical memory addresses are located.

9. The method of claim 8, wherein:
the at least one process is to allocate, at least in part, the one or more physical memory addresses in response, at least in part, to and contemporaneous with invocation of a memory allocation function call; and
the at least one process comprises at least one operating system kernel process.

10. The method of claim 8, wherein:
the circuitry comprises:
first circuitry and second circuitry to concurrently generate, at least in part, respective values indicating, at least in part, the at least one memory, based at least in part upon the memory line-by-memory line allocation and the page-by-page allocation, respectively; and
selector circuitry to select one of the respective values based at least in part upon the one or more physical addresses and in which of the physical memory regions the one or more physical memory addresses are located.

11. The method of claim 7, wherein:
the plurality of processor cores are communicatively coupled to each other via at least one network-on-chip;
the at least one page comprises, at least in part, at least one packet received, at least in part, by a network interface controller, the at least one packet including the data; and
the plurality of processor cores, the memories, and the network-on-chip are comprised in an integrated circuit chip.

12. The method of claim 7, wherein:
the at least one memory is local to the at least one of the processor cores and also is remote from one or more others of the processor cores;
the at least one of the processor cores comprises multiple processor cores to execute respective application threads to utilize, at least in part, the at least one page; and
the at least one page is allocated, at least in part, by at least one virtual machine monitor process.

13. Computer-readable memory storing one or more instructions that when executed by a machine result in performance of operations comprising:
selecting, at least in part, by circuitry, from a plurality of memories at least one memory to store data, the plurality of memories being associated with respective processor cores, the circuitry being to select, at least in part, the at least one memory based at least in part upon whether the data is comprised in at least one page that spans multiple memory lines that is to be processed by at least one of the processor cores, and if the data is comprised in the at least one page, the circuitry being to select, at least in part, the at least one memory, such that the at least one memory is proximate to the at least one of the processor cores.

14. The computer-readable memory of claim 13, wherein:
the at least one page is allocated, at least in part, one or more physical memory addresses by at least one process executed, at least in part, by one or more of the processor cores;
the one or more physical memory addresses are in a first physical memory region associated, at least in part, with one or more first data portions to be distributed to the memories based at least in part upon a page-by-page allocation;
the at least one process is to allocate, at least in part, a second physical memory region associated, at least in part, with one or more second data portions to be distributed to the memories based at least in part upon a memory line-by-memory line allocation; and
the circuitry is to select, at least in part, the at least one memory based at least in part upon the one or more physical addresses and in which of the physical memory regions the one or more physical memory addresses are located.

15. The computer-readable memory of claim 14, wherein:
the at least one process is to allocate, at least in part, the one or more physical memory addresses in response, at least in part, to and contemporaneous with invocation of a memory allocation function call; and
the at least one process comprises at least one operating system kernel process.

16. The computer-readable memory of claim 14, wherein:
the circuitry comprises:
first circuitry and second circuitry to concurrently generate, at least in part, respective values indicating, at least in part, the at least one memory, based at least in part upon the memory line-by-memory line allocation and the page-by-page allocation, respectively; and
selector circuitry to select one of the respective values based at least in part upon the one or more physical addresses and in which of the physical memory regions the one or more physical memory addresses are located.

17. The computer-readable memory of claim 13, wherein:
the plurality of processor cores are communicatively coupled to each other via at least one network-on-chip;
the at least one page comprises, at least in part, at least one packet received, at least in part, by a network interface controller, the at least one packet including the data; and
the plurality of processor cores, the memories, and the network-on-chip are comprised in an integrated circuit chip.

18. The computer-readable memory of claim 13, wherein:
the at least one memory is local to the at least one of the processor cores and also is remote from one or more others of the processor cores;
the at least one of the processor cores comprises multiple processor cores to execute respective application threads to utilize, at least in part, the at least one page; and
the at least one page is allocated, at least in part, by at least one virtual machine monitor process.
